(19) United States
(12) Patent Application Publication
(10) Pub. No.: US 2017/0013796 A1
(43) Pub. Date: Jan. 19, 2017

(54) MILKING DEVICE FOR MILKING DAIRY CATTLE

(71) Applicant: DIEHL METALL STIFTUNG & CO. KG, Roethenbach (DE)

(72) Inventors: VOLKER BRAEUTIGAM, ERLANGEN (DE); ALEXANDER DEHNELT, NUERNBERG (DE)

(21) Appl. No.: 15/278,170

(22) Filed: Sep. 28, 2016

Related U.S. Application Data
(63) Continuation of application No. PCT/EP2014/000848, filed on Mar. 29, 2014.

(51) Int. Cl. A01J 5/04

(52) U.S. Cl. CPC A01J 5/044; A01J 5/041

(57) ABSTRACT

A milking device for milking dairy cattle contains at least one teat cup which is connected to a milk-collecting container by a hose. In order to simplify the production of the milking device, at least one surface coming in contact with the milk or one component of the teat cup and/or of the milk-collecting container is made of an alloy that contains at least 50% Cu and, as a further alloying constituent, at least 2% Zn or at least 2% Sn.

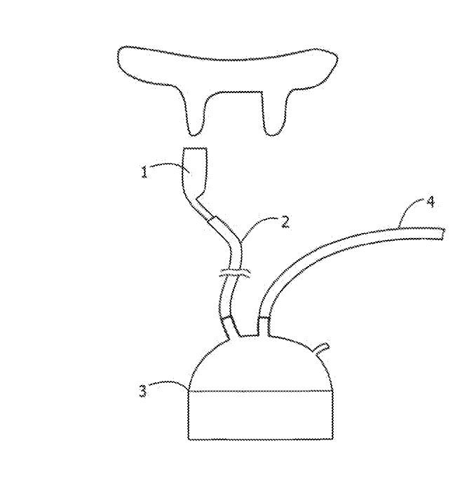

### CROSS-REFERENCE TO RELATED APPLICATION

This is a continuation application, under 35 U.S.C. §120, of copending international application No. PCT/EP2014/000848, filed Mar. 29, 2014, which designated the United States.

### BACKGROUND OF THE INVENTION

Field of the Invention

The invention relates to a milking device for milking dairy cattle.

Such a milking device is generally known according to the prior art.

For milking, the teat cups are slipped onto the teats of the udder. A pulsating vacuum is applied to the teat cups. As a consequence, milk passes into the teat cups and is conveyed via a hose to a milk-collecting container. Thence, the milk is pumped into a milk cooling tank.

According to the prior art, both the teat cups and the milk-collecting container are made of stainless steel. In this case, they are produced by deep-drawing and welding. This is laborious.

Using conventional milking devices, it is impossible to always ensure that a legal limit value for what is termed the “germ density” of 400,000 SCC/ml is observed. Irrespective of this, germ-contaminated teat cups can cause germ transmission from animal to animal.

### SUMMARY OF THE INVENTION

The object of the invention is to do away with the drawbacks of the prior art. The intention is in particular to specify a milking device which is simple to produce. According to another aim of the invention, the germ density in the milk should be safely and reliably kept below the legal maximum value. Finally, germ transmission from animal to animal should be counteracted.

In accordance with the invention, it is proposed that at least one surface or component, of the teat cup and/or of the milk-collecting container, which comes into contact with the milk is made of an alloy that contains at least 50% Cu and as additional alloy constituent at least 2% Zn or at least 2% Sn. It has been found that use of the alloy proposed in the invention makes it possible to produce the teat cup and/or the milk-collecting container simply and cost effectively by casting or forging. In particular, it is no longer necessary to join multiple components by welding or to deep-draw components, which is laborious. In addition, the proposed alloy has antimicrobial properties. As a consequence, the germ density in the milk and the risk of germ transmission from animal to animal can be reduced.

Furthermore, the proposed alloy has exceptional corrosion resistance, in particular with respect to the aggressive conditions that are found in the milking stalls. The proposed alloy satisfies the usual strength requirements. In particular, use of the alloy according to the invention makes it possible to produce the teat cup and/or the milk-collecting container with the necessary surface quality. It is advantageously possible to set an average roughness Ra of the surface to a value in the range from 0.5 to 1.0 μm.

According to one advantageous embodiment, the alloy contains at least 55% Cu, preferably at least 60% Cu. It can in particular contain at least 60% Cu and at least 3% Zn.

According to another embodiment, the alloy contains at least 1.5% Si, preferably at most 15% Si, particularly preferably 2% to 7% Si.

In the case of a CuZn alloy, the alloy can contain between 8% and 40% Zn.

As additional alloy constituent, the alloy can contain 0.01% to 0.3% P. In addition, the alloy can contain, as grain refiner, (i) 0.0005% to 0.5% B or (ii) 0.0005% to 0.02% Zr. Such alloys are particularly suitable as casting alloys.

In particular, the alloy can also be what is termed a “gunmetal alloy” that contains at least 2% Zn and at least 2% Sn.

In order to improve cast ability, the alloy can contain, as additional alloy constituent, 0.2% to 8.0% Al.

Particular preference is given to the following alloys: CuZn21Si3PB, preferably with 0.07% P and 0.007% B, CuZn16Si4, CuZn10Si4MnP.

The teat cup and/or the milk-collecting container can be of multi-part construction, wherein only one component—in particular that which comes into contact with the milk—is made of the alloy. This means that the teat cup can for example be made of plastic and have a thin-walled insert (or a corresponding coating) made of the alloy. It is similarly also possible for the milk-collecting container to be made for example of plastic and to have an insert made of the alloy.

Advantageously, the teat cup is made in one piece from the alloy. The teat cup and/or the milk-collecting container can in particular be made from the alloy by casting, preferably by die casting. The milk-collecting container can also be made from the alloy by forging or cold-forming. It can comprise a milk-collecting pot and a matching lid.

A wall thickness of the teat cup and/or of the milk-collecting container is expediently 1.0 mm to 2.5 mm, preferably 1.2 mm to 1.9 mm, particularly preferably 1.5 mm.

The above-mentioned alloys of course always have a residual quantity of unavoidable contaminants. The above-mentioned secondary alloy constituents Zn, Sn, Si, P, B, Zr, Al replace, in the contents specified, in each case a corresponding content of the main alloy constituent Cu, i.e. a difference or a remainder to 100% consists of Cu.

### EXAMPLES

1. Teat cup made by die casting from the alloy CuZn21Si3PB.
2. Milk-collecting container made by forging from the alloy CuZn40.
3. Teat cup made by die casting from silicon tombac, i.e. CuZn16Si4—C

Other features which are considered as characteristic for the invention are set forth in the appended claims.

Although the invention is illustrated and described herein as embodied in a milking device for milking dairy cattle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single figure of the drawing is a diagrammatic illustration of a milking device according to the invention.

### DETAILED DESCRIPTION OF THE INVENTION

Referring now to the single figure of the drawing in detail, there is shown schematically a milking device. The milking device has a teat cup 1 connected to a milk-collecting container 3 via a hose 2. The reference sign 4 indicates a vacuum hose which is connected to the milk-collecting container 3 and which is connected to a non-illustrated vacuum source.

The following is a summary list of reference numerals and the corresponding structure used in the above description of the invention:
1 Teat cup
2 Hose
3 Milk-collecting container
4 Vacuum hose

1. A milking device for milking dairy cattle, comprising:
a hose;
a milk-collecting container; and
at least one teat cup connected via said hose to said milk-collecting container, at least one surface or component, of at least one of said teat cup or of said milk-collecting container, which comes into contact with milk is made of an alloy that contains at least 50% Cu and as an additional alloy constituent at least 2% Zn or at least 2% Sn.

2. The milking device according to claim 1, wherein said alloy contains at least 55% Cu.

3. The milking device according to claim 1, wherein said alloy contains at least 1.5% Si.

4. The milking device according to claim 1, wherein said alloy contains between 8% and 40% Zn.

5. The milking device according to claim 1, wherein said alloy contains 0.01% to 0.3% P.

6. The milking device according to claim 1, wherein said alloy contains, as a grain refiner, (i) 0.0005% to 0.5% B or (ii) 0.0005% to 0.02% Zr.

7. The milking device according to claim 1, wherein said alloy contains at least 2% Zn and at least 2% Sn.

8. The milking device according to claim 1, wherein said alloy contains 0.2% to 8.0% Al.

9. The milking device according to claim 1, wherein said alloy is chosen from the group consisting of CuZn21Si3PB, CuZn16Si4 and CuZn10Si4MnP.

10. The milking device according to claim 1, wherein said teat cup is made in one piece from said alloy.

11. The milking device according to claim 1, wherein at least one of said teat cup or said milk-collecting container is made from said alloy by casting.

12. The milking device according to claim 1, wherein said milk-collecting container is made from said alloy by forging or cold-forming.

13. The milking device according to claim 1, wherein said alloy contains at least 60% Cu.

14. The milking device according to claim 1, wherein said alloy contains at most 15% Si.

15. The milking device according to claim 1, wherein said alloy contains 2% to 7% Si.

16. The milking device according to claim 1, wherein at least one of said teat cup or said milk-collecting container is made from said alloy by die casting.
